(19) United States
(12) Patent Application Publication
(10) Pub. No.: US 2001/0024730 A1
(43) Pub. Date: Sep. 27, 2001

(54) Apparatus for enhancing extruded plolyethylene terephthalate (PET) film adhesion to a cellulosic substrate

(75) Inventors: George Mervin Broce, Covington, VA (US); Barry Gene Calvert, Covington, VA (US); Haralambos Cordatos, Eldersburg, MD (US)

Correspondence Address: Donald L. Bowman, Esq., Westvaco Corp. - Law Dept., Mill Road - Research, Covington, VA, 24426, US

(73) Assignee: Westvaco Corporation

(21) Appl. No.: 09/835,152

(22) Filed: Apr. 13, 2001

Related U.S. Application Data
(62) Division of application No. 09/395,827, filed on Sep. 13, 1999.

(51) Int. Cl. B05C 1/10; B05D 1/38; B32B 27/10

(52) U.S. Cl. 428/481; 118/67; 427/389.9; 427/391

(57) ABSTRACT

This invention relates to an apparatus and method for enhancing extruded polyethylene terephthalate (PET) film adhesion to a cellulosic substrate. Such structures of this type, generally, use specialized primers which are applied in-line on the extruder such that the adhesion of PET to the cellulosic substrate can be greatly increased. This is accomplished by improvement of the chemical bond between the polymer film and substrate/primer.

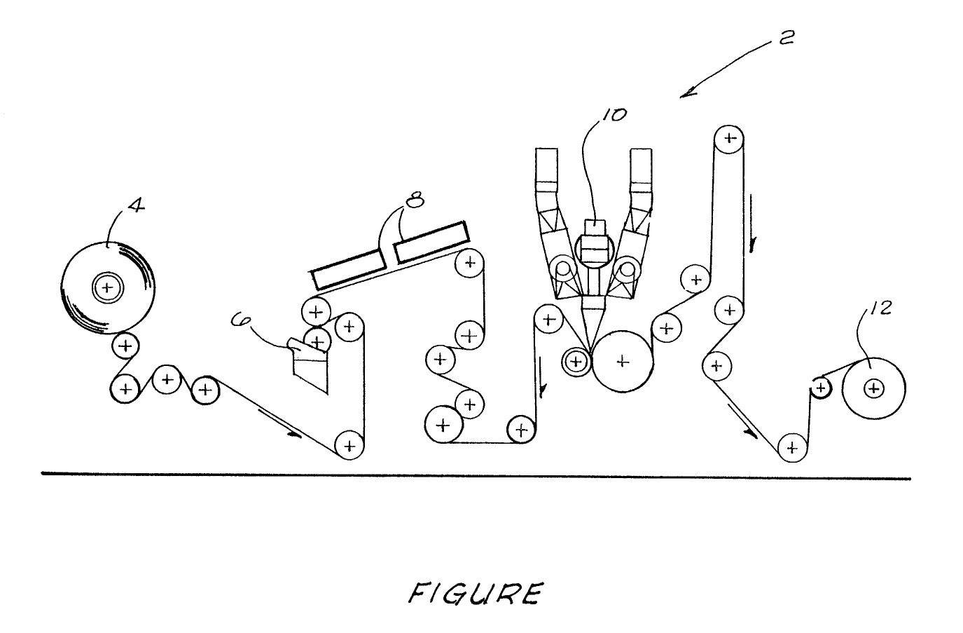

### BACKGROUND OF THE INVENTION

1. Field of the Invention

This invention relates to an apparatus and method for enhancing extruded polyethylene terephthalate (PET) film adhesion to a cellulosic substrate. Such structures of this type, generally, use specialized primers which are applied in-line on the extruder such that the adhesion of PET to the cellulosic substrate can be greatly increased. This is accomplished by improvement of the chemical bond between the polymer film and substrate/primer.

2. Description of the Related Art

When a cellulosic substrate such as paper or paperboard is extrusion coated with polymer, the polymer film formed during the process must have adequate adhesion to the substrate in order to withstand subsequent converting and end-use requirements. Historically, when extrusion coating the above-mentioned polymer onto the substrate adhesion could be determined adequate at “ambient” conditions; however, adhesion could be poor at higher humidity conditions (higher substrate moisture content). During the extrusion process, the polymer adheres to the substrate both through establishing chemical bonds and mechanically locking around the fibers on the surface of the substrate. This “break down” of adhesion strength at the higher humidity levels is a result of chemical bond degradation.

The main end-use for a paperboard substrate coated with PET is in the frozen food market where the paperboard is formed into a carton which serves as a vessel to hold, distribute, and reconstitute the food. This food vessel is subjected to many different environments during this process, usually including one of high humidity, such as in a freezer, refrigerator or during distribution. Reduced adhesion can result in inferior carton performance due to the film layer separating from the paperboard. If adhesion could be improved at higher humidity levels (higher board moisture content) it would be of great value due to increased carton end-use performance.

Historically, running higher PET coat weights has been the method to cope with the above phenomena. The high coat weight would improve the mechanical bond enough to overcome the break down of the chemical bond at the higher humidity levels. However, the drawbacks of this method are mainly higher cost due to increased use of polymer and a detrimental effect on converting and heat sealing.

With respect to polyethylene (PE)—coated paper, such as for ink jet printing paper, the paper cannot be heated beyond 120° C. because of the low melting point of PE. This makes it unsuitable as a substrate for high-temperature applications, such as electrophotography, limits the range of available curing chemistries for ink jet receiving coatings, and slows down ink jet coating lines because driers must operate at low temperature. Also, it is known that adhesion of PET to the smooth surface of fine papers, regardless of coat weight, cannot be achieved.

It is known, in paperboard packaging, to manufacture a material via the adhesion lamination process. Exemplary of such prior art is U.S. Pat. No. 4,900,594 ('594) to J. R. Quick et al., entitled “Pressure Formed Paperboard Tray With Oriented Polyester Film Interior.” This process involves the use of film manufactured in a separate process then adhered to the paperboard via an adhesive. However, there is no reference to film adhesion at high humidity.

It is also known to adhere PET to paper. Exemplary of such prior art are U.S. Pat. No. 3,904,104 ('104) to W. P. Kane, entitled “Polyethylene Terephthalate/Paperboard Blank and Container Formed From Such Blank,” U.S. Pat. No. 3,924,013 ('013) to W. P. Kane, entitled “Method of Cooking Food in a Polyethylene Terephthalate/Paperboard Laminated Container,” U.S. Pat. No. 3,939,025 ('025) to W. P. Kane, entitled “Method of Making a Polyethylene Terephthalate Laminate,” and U.S. Pat. No. 3,967,998 ('998) to W. P. Kane, entitled “Polyethylene Terephthalate/Paperboard Laminate and Method of Making it, Container Blank Formed From Such Laminate and Container Formed From Such Blank, and Cooking Method Using Such Container.” For adhering PET to paperboard, the '104, '013, '025, and '998 references describe heating an uncoated paper surface to at least 285° F. by means of flame or hot gas. The paper should be in a pH range 7-7.5 and the intrinsic viscosity of the PET should be in the range of 0.51-0.85. However, no coat weights or adhesion characteristics at high moisture levels are given.

It is further known to improve the adhesion of PET via the coextrusion process. Exemplary of such prior art is U.S. Pat. No. 4,455,184 ('184) to K. P. Thompson, entitled “Production of Laminate Polyester and Paperboard.” The process of the '184 reference involves the use of a layer of Ethylene Methyl Acrylate (EMA), Ethylene Vinyl Acetate (EVA) or blends containing these components. The materials described for promoting the adhesion all have low melt temperatures compared to PET. Consequently, this imbalance of melt temperatures limits the end-use range of the materials. For example, the PET film would delaminate when forming cartons via hot air due to the low melt temperature of the adhesive layer and cause blisters. Also, there is no reference to PET adhesion at high humidity in the '184 reference.

Finally, it is known to employ a process to improve PET adhesion via corona treatment. Exemplary of such prior art is U.S. Pat. No. 4,147,836 ('836) to S. W. Middleton et al., entitled “Polyester Coated Paperboard for Forming Food Containers and Process for Producing the Same.” Again, as with previous reference, the '836 reference does not disclose adhesion of PET at high humidity.

It is apparent from the above that there exists a need in the art for an apparatus and method that is capable of adhering polyethylene terephthalate (PET) to a cellulosic substrate through simplicity of parts and uniqueness of structure, and which at least equals the adhesion characteristics of the known apparatus and method, but which at the same time enhances the adhesion of PET to a cellulosic substrate. It is the purpose of this invention to fulfill this and other needs in the art in a manner more apparent to the skilled artisan once given the following disclosure.

### SUMMARY OF THE INVENTION

Generally speaking, this invention fulfills these needs by providing a method for enhancing extruded polyethylene terephthalate (PET) film adhesion to a cellulosic substrate, wherein said method is comprised of the steps of: coating a cellulosic substrate with a layer of a water-based PET primer emulsion; drying the primer emulsion layer; and coating the primer emulsion layer with a layer of PET.

In certain preferred embodiments, the water-based PET primer is applied at a coat weight rate of 0.5-6 pounds/3000 sq. ft. Also, the PET layer is applied over the primer in a coat weight rate of 6-30 pounds/3000 sq. ft. Finally, the cellulosic substrate is paper and/or paperboard.

In another further preferred embodiment, through the use of the specialized primer applied on-line by the extruder, adhesion of PET to paperboard can be greatly increased at high humidity levels. Added benefits include reduced costs due to lower than typical coat weights and faster extruder line speed.

The preferred method, according to this invention, offers the following advantages: good stability; good durability; excellent economy; reduced coat weights; enhanced adhesion; and faster extruder line speeds. In fact, in many of the preferred embodiments, these factors of excellent economy, reduced coat weights, enhanced adhesion, and faster extruder line speeds are optimized to an extent that is considerably higher than heretofore achieved in prior, known PET coating systems.

### BRIEF DESCRIPTION OF THE DRAWING

The above and other features of the present invention, which will become more apparent as the description proceeds, are best understood by considering the following detailed description, in conjunction with the accompanying drawing, in which the single FIGURE is a cross sectional view of a extrusion coater with a primer station, according to the present invention.

### DETAILED DESCRIPTION OF THE INVENTION

With reference first to the FIGURE, there is illustrated an advantageous environment for use of the concepts of this invention. In particular, extrusion coater 2 is illustrated. Coater 2 includes, in part, unwind roll 4, primer coating unit 6, primer drying section 8, conventional extruder 10, and rewind roll 12.

Paperboard unwound roll 4 is produced from a cellulosic substrate, such as a 0.018 inch thick bleached sulfate sheet. Definitely, the term paperboard describes paper within a thickness range of 0.012-0.024 inches. The invention is relative to the full scope of such a range, as applied to packaging and beyond.

In use for food carton stock, paperboard is usually clay coated on at least one side surface and frequently on both sides. The paperboard trade characterizes a paperboard web or sheet that has been clay coated on one side as C1S and as C2S for a sheet coated on both sides. Compositionally, this paperboard coating is a fluidized blend of minerals such as coating clay, calcium carbonate, and/or titanium dioxide with starch which is smoothly applied to the traveling web surface. Successive densification and polishing by calendering finishes the mineral coated surface to a high degree of smoothness in the superior graphics print surface. Preferably, in the present invention, the paperboard formed into roll 4 is C1S paperboard with the particulate mineral coating being located on the side of the paperboard not in contact with the primer or the PET coating.

It is to be understood that uncoated paper in the thickness range of 0.004 and 0.01 inches can also be coated, according to the present invention. The uncoated paper is conventionally machine finished.

During the operation of coater 2, paper or paperboard is unwound from roll 4 and precedes past primer coating unit 6. The method of primer application is preferably via gravure; however, other techniques such as rod, roll, blade or other means capable of applying a solution can be incorporated. Prior to the printer application, the paper/paperboard web should be heat treated by a conventional flame or corona treatment.

If applied to paperboard, the primer, preferably, is formulated from a water-based PET emulsion produced by the Mica Corporation of Stratford, Conn., under the product identification of M-1173. Other primers manufactured or compounded from Eastman Chemical's (Kingsport, Tenn.) line of water-based PET emulsions by other coating companies such as Michelman, Inc. Of Cincinnati, Ohio, have also performed well in promoting adhesion to paperboard at high humidity levels. The optimal primer application coat weight for the material described is around 2 pounds/3000 sq. ft. wet. A range of 0.50-6 pounds/3000 sq. ft. wet will also provide adhesion improvement.

If applied to paper, the primer, preferably, is formulated from a water-based PET emulsion produced by the Mica Corporation of Stratford, Conn., under the product identification of M-1173. Other primers manufactured or compounded from Eastman Chemical's (Kingsport, Tenn.) line of water-based PET emulsions by other coating companies such as Michelman, Inc. Of Cincinnati, Ohio, have also performed well in promoting adhesion to paper. The optimal primer application coat weight for the material described is around 6 pounds/3000 sq. ft. wet. A range of 1.5-18 pounds/3000 sq. ft. wet will also provide adhesion improvement.

As the attached FIGURE indicates, drying of the applied primer prior to extrusion coating is necessary. Flame treatment, typically, used for promotion of PET adhesion, is not necessary with the primer method described in the present invention. Drying, preferably, is carried out by a conventional forced air or infrared heater.

The PET coat weight applied on extruder 10 over the primer is in the range of 6-30 pounds/3000 sq. ft. with the optimal being around 9 pounds/3000 sq. ft. Finally, the primed and PET coated paper/paperboard web is wound upon rewind roll 12.

For fine papers, preferably, the PET is pigmented with a blend of anatase TiO₂ (preferably 15%), an ultramarine blue pigment (300 ppm expressed as a % weight of the extrusion coated layer), and a optical brightener (300 ppm optical brightener such as OB3, manufactured by Eastman Chemical). This pigmented PET has a blue tint and decreased yellowness. This PET coating is applied over a coatweight range of 9-14 pounds/3000 sq. ft. with the optimal coat weight being 10-11 pounds/3000 sq. ft. In this manner, the paper, coated according to the present invention would have a structure from top to bottom of:

(un)pigmented PET/primer/uncoated fine paper/primer/(un)pigmented PET

In order to demonstrate the efficacy of the present invention, typical PET ovenable paperboard was compared with a PET extruded ovenable paperboard produced, according to the present invention. Below is Table 1 of the test results.

TABLE 1

| | MD/CD Adhesion | MD/CD Adhesion |
|---|---|---|
| Sample | @70F/50% RH | @80F/80% RH |
| Conventional Ovenable | Yes | No |
| PET ovenable with primer | Yes | Yes |

The water-based primer from Mica, Inc. was used to investigate possible adhesion improvements for ovenable paperboard. The primer samples were prepared using a conventional #3 wire wound rod on a conventional lab coater and dried for 15 seconds in a 250° F. oven. The wet weight application for the primer was approximately 1.9 pounds/3000 sq. ft. using the #3 wire wound rod. The #3 rod was chosen to emulate previously successful gravure roll applications.

For the extrusion coated primer sample, the burners were turned off to prevent premature activation of the primer. The unprimed paperboard produced during the primer trial (burner off) had no adhesion. Polyester coat weights for the test were conventionally applied in the 7-8 pounds/3000 sq. ft. range. Both the conventional ovenable paperboard and the primer coated paperboard of the present invention had good adhesion at time of manufacture. Samples of conventional ovenable board and paperboard produced, according to the present invention, were subjected to specific humidity/temperature conditioning and tested for adhesion. As one can see, at high humidity conditions [80% relative humidity (RH)], the conventional paperboard did not provide proper adhesion. Conversely, the primed, PET coated paperboard exhibited adhesion at this high humidity.

The method described in the present invention allowed the preparation of PET-coated fine papers intended for use in digital printing or other applications that would benefit from PET. As discussed earlier, PET does not readily adhere onto the smooth, machine finished surface of fine papers even at high coat weights. Hence, the only prior option for preparation of such products was to utilize some sort of adhesive layer, such as an extrusion coated tie layer used in the previously discussed '184 reference.

In particular, Ethylene Methyl Acrylate copolymer (EMA), was evaluated as a tie layer between pigmented PET and a conventional fine paper. Equistar's EM 806-009 ethylene methyl acrylate copolymer (6 g/10 min melt index), containing 20% methyl acrylate, was used. A conventional machine finished fine paper was used. Pigmented (Eastman SB038-03AP) PET was used only after runnability was established; unpigmented PET (Eastman 9921) was used for most conditions. The substrate's surface was pretreated with a conventional flame treatment. Typical line speed was 350 ft/min and the air gap was maintained at 6″. A glossy chill roll was used for all conditions.

Fiber tear adhesion was obtained even at the lowest coat weights attempted, namely 2 lb/3000 ft² for EMA and 15 lb/3000 ft² for PET. However, when samples were placed in a convection oven at 300° F., they blistered within 5-10 sec.

Surprisingly, fiber tear adhesion was also obtained when the aqueous primer of the present invention was applied in line with a gravure roll at approximately 2.4 lb/3000 ft² wet. The pigmented PET was the same, albeit the coat weight where fiber tear adhesion was obtained was as low as approximately 9 lb/3000 ft², the lowest attempted in this experiment. The paper was flame treated immediately prior to primer application, and the primer was fully dried by forced air before the web reached the PET melt. Flame treatment after primer application was avoided to prevent damaging the primer. Samples obtained from these experiments were placed in a conventional oven at 300° F. for at least one minute and no blisters were detected. These pigmented PET-coated papers had superior gloss (20° gloss: approximately 100), CIE brightness approximately 89 and whiteness approximately 94 (CIELAB 10°/D65/RSEX).

Once given the above disclosure, many other features, modifications or improvements will become apparent to the skilled artisan. Such features, modifications or improvements are therefore, considered to be a part of this invention, the scope of which is to be determined by the following claims.

What is claimed is:

1. A method for enhancing extrusion coated polyethylene terephthalate (PET) film adhesion to a cellulosic substrate, wherein said method is comprised of:
coating a first side of a cellulosic substrate web with a layer of a water-based PET primer emulsion;
drying said primer emulsion layer; and
coating said primer emulsion layer with a layer of PET.

2. The method, as in claim 1, wherein said primer emulsion is applied at a coat weight rate of 1.5-18 pounds/3000 sq. ft. wet.

3. The method, as in claim 2, wherein said primer emulsion is applied at a coat weight rate of approximately 6 pounds/3000 sq. ft. wet.

4. The method, as in claim 1, wherein said PET layer is applied at a coat weight rate of 6-30 pounds/300 0 sq. ft.

5. The method, as in claim 4, wherein said cellulosic substrate is further comprised of:
paper.

6. The method, as in claim 4, wherein said cellulosic substrate is further comprised of:
paperboard.

7. An apparatus for enhancing extrusion coated polyethylene terephthalate (PET) film adhesion to a cellulosic substrate, wherein said apparatus is comprised of:
a cellulosic substrate web roll;
a primer coating unit located upstream of said roll for applying a water-based PET primer emulsion substantially over a said cellulosic substrate web;
a primer coating dryer means located upstream of said primer coating unit for drying said layer of said primer;
a PET extruder means located upstream of said dryer means for applying a coating of PET; and
a coated paperboard web rewind means for rewinding said primed and PET-coated paperboard web.

8. The apparatus, as in claim 7, wherein said primer emulsion is applied at a coat weight rate of 1.5-18 pounds/3000 sq. ft. wet.

9. The apparatus, as in claim 8, wherein said primer emulsion is applied at a coat weight rate of approximately 6 pounds/3000 sq. ft. wet.

10. The apparatus, as in claim 7, wherein said PET layer is applied at a coat weight rate of 6-30 pounds/3000 sq. ft.

11. The apparatus, as in claim 7, wherein said cellulosic substrate is further comprised of:
paper.

12. The apparatus, as in claim 7, wherein said cellulosic substrate is further comprised of:
paperboard.

13. A cellulosic laminate which has enhanced extrusion coated polyethylene terephthalate (PET) adhesion, wherein said substrate is comprised of:
a cellulosic substrate;
a layer of a water-based PET primer emulsion located adjacent to said cellulosic substrate; and
a layer of PET located substantially over said primer emulsion layer.

14. The laminate, as in claim 13, wherein said primer emulsion is applied at a coat weight rate of 1.5-18 pounds/3000 sq. ft. wet.

15. The laminate, as in claim 14, wherein said primer emulsion is applied at a coat weight rate of approximately 6 pounds/3000 sq. ft. wet.

16. The laminate, as in claim 13, wherein said PET layer is applied at a coat weight rate of 6-30 pounds/3000 sq. ft.

17. The laminate, as in claim 16, wherein said cellulosic substrate is further comprised of:
paper.

18. The laminate, as in claim 16, wherein said cellulosic substrate is further comprised of:
paperboard.

19. The laminate, as in claim 17, wherein said PET layer is applied at a coatweight of 9 pounds/3000 sq. ft.

20. The laminate, as in claim 18, wherein said PET layer is applied at a coatweight of 10-11 pounds/3000 sq. ft.
